(19) United States
(12) Patent Application Publication
(10) Pub. No.: US 2018/0145535 A1
(43) Pub. Date: May 24, 2018

(54) Solar Recharging Station

(71) Applicant: Mathubrew Inc., East Longmeadow, MA (US)

(72) Inventor: Matthew Reed, East Longmeadow, MA (US)

(21) Appl. No.: 15/356,658

(22) Filed: Nov. 20, 2016

(51) Int. Cl. H02J 7/35; H02J 7/00; H02M 7/44

(52) U.S. Cl. CPC H02J 7/355; H02J 2007/0062; H02M 7/44; H02J 7/0052

(57) ABSTRACT

The current invention is a solar recharging station with an ergonomic rectangular base with a handle on top. The charging station is light weight and has two doors in the front that open. The base is placed flat on its back. The inside of the doors and the top of the base have a plurality of electronic solar cells and panels. The handle will side back to reveal a number of electronic ports and outlets. These outlets are hidden by the handle when the charging station is not in use.

### CROSS-REFERENCES TO RELATED APPLICATIONS (IF ANY)

This application claims the priority date of Provisional Application No. 62/285,813 filed on Nov. 9, 2015.

### BACKGROUND

### 1. Field of the Invention

This invention relates to a solar recharging station and system and more particularly one that is easy to use, store and carry.

### 2. Description of Prior Art

There are a lot of times that a person would need power when access to a standard power supply is not available. These can be Emergency situations, Beach, boating, road trips, daily device charging, disaster relief, safe on planes, linkable, hiking woodland trails, lazing on a beach, late night barbeques, and trying to entertain the family after dark with a flashlight.

Because getting away from it all sounds great. But these days it can be a scary prospect. When the sun goes down and out of contact, what happens if disaster strikes. Being out of power and out of reach, could put a family in danger.

This is also true in the case of emergencies when the power is out or during car trips where there are no stops.

Gas generators are heavy and take away from the feel of nature while stored batteries are heavy and hard to carry.

There is still room for improvement in the art.

### SUMMARY OF THE INVENTION

The current invention is a solar recharging station that is:
Solar Powered—Natural solar energy that offers real time charging;
12 Volt Battery—Provides enough intensity to power multiple devices;
Trickle Charge Adapter—For fast traditional charging; and
Portable—Foldable panels and easy-to-carry handle so you can take it anywhere.

It is comprised of an ergonomic rectangular base with a handle on top. The charging station is light weight and has two doors in the front that open. The base is placed flat on its back and the doors are opened when charging. The inside of the doors and the top of the base have a plurality of electronic solar cells and panels. When opened these panels created electricity that can be used to run electronic devices or be used to charge rechargeable batteries for later usage.

The handle will side back to reveal a number of electronic ports and outlets. These outlets are hidden by the handle when the charging station is not in use.

The charging station will have a 12 Volt self contained power system, High end solar panels, 2 USB ports, Power outlets of household receptacles, LED screen for tracking. It will have an easy to carry handle and a durable outer shell.

It is an improvement over the current art.

### BRIEF DESCRIPTION OF THE DRAWINGS

Without restricting the full scope of this invention, the preferred form of this invention is illustrated in the following drawings:

FIG. 1 is a view of the current invention in its storage and carrying configuration;

FIG. 2 is a view of the current invention for charging and usage;

FIG. 3 displays the solar power cells with the power cell doors open;

FIG. 4 shows the bottom of the invention in travel and storage mode;

FIG. 5 shows the top of the invention in travel and storage mode;

FIG. 6 shows the control panel of the charging station; and

FIG. 7 shows some of the electronic components in the base in a cut away view.

### DESCRIPTION OF THE PREFERRED EMBODIMENT

There are a number of significant design features and improvements incorporated within the invention.

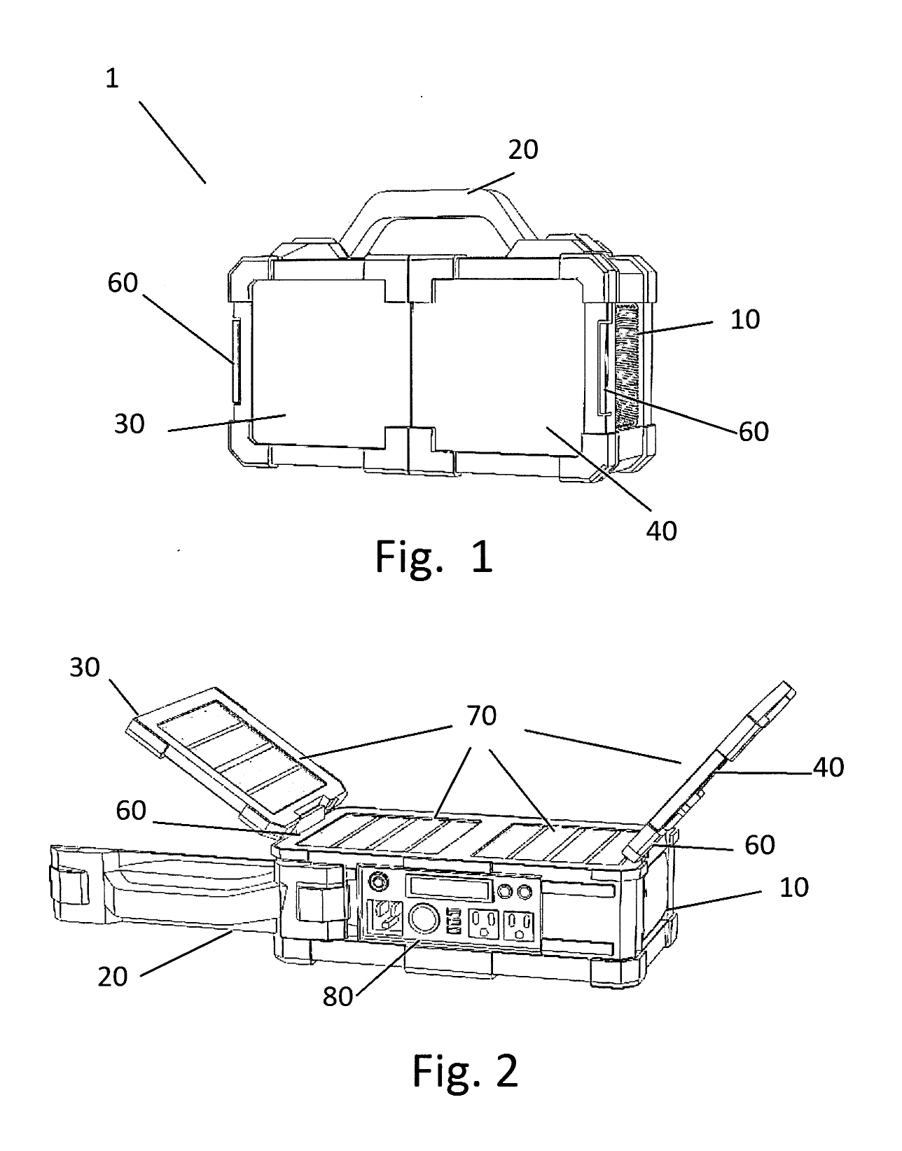

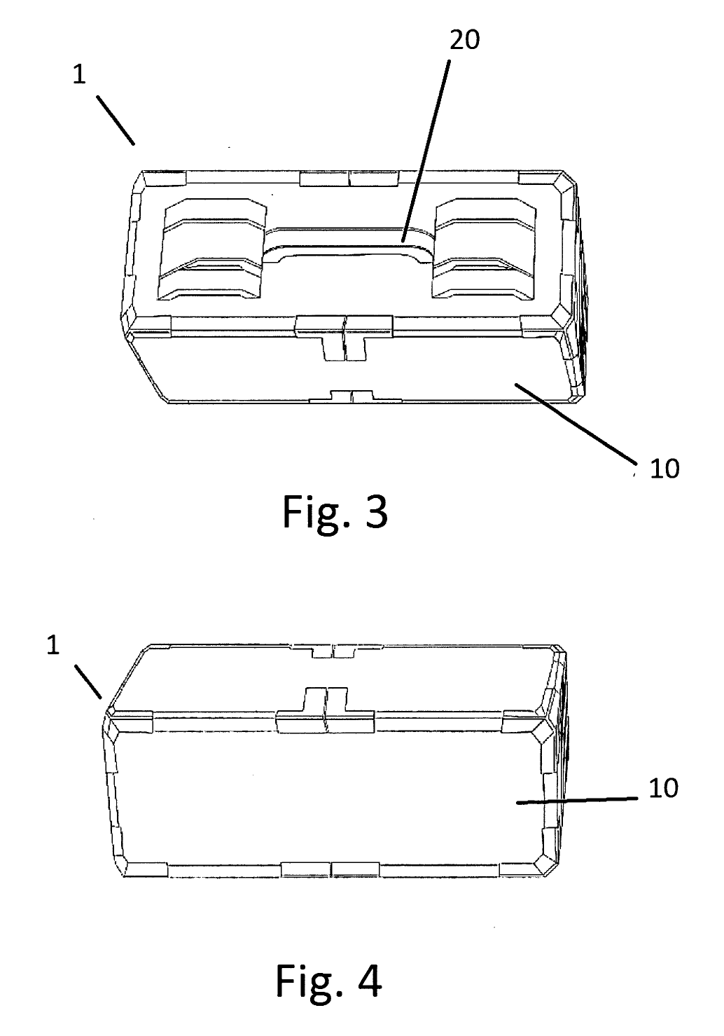

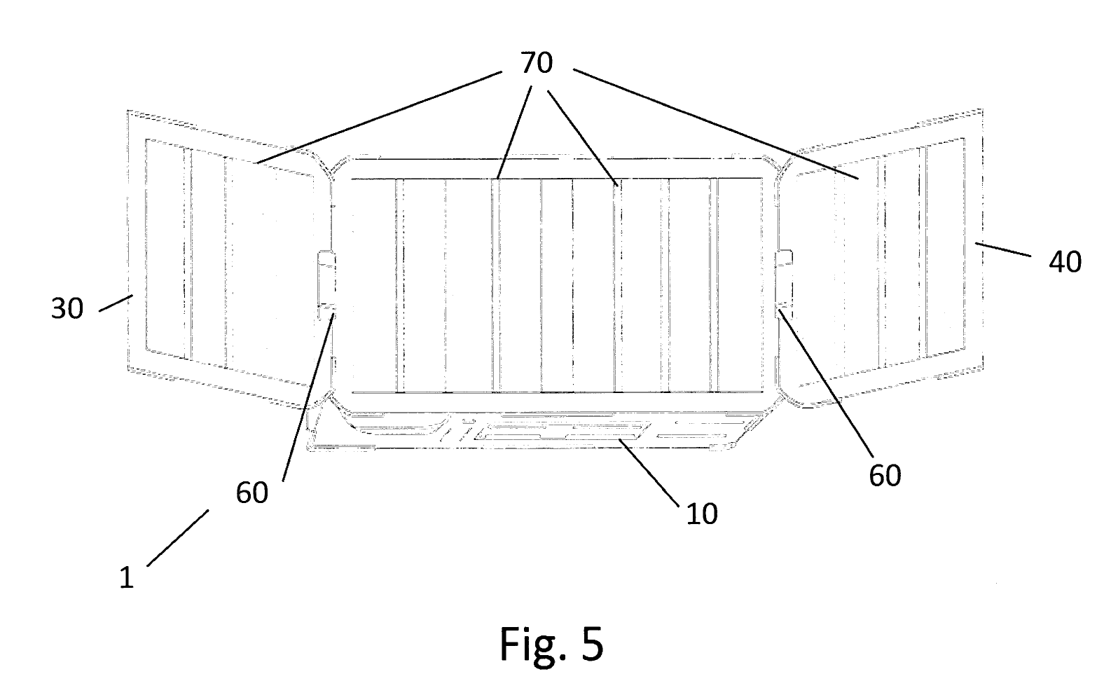

The current invention is a solar recharging station 1 as shown in FIG. 1-7. It is comprised of an ergonomic rectangular base 10 with a handle 20 on top. The charging station 1 is light weight and has two doors 30, 40 in the front that open. The base is placed flat on its back. The inside of the doors and the top of the base 10 have a plurality of electronic solar cells and panels 70. When opened these panels 70 created electricity that can be used to run electronic devices or be used to charge rechargeable batteries 200 for later usage.

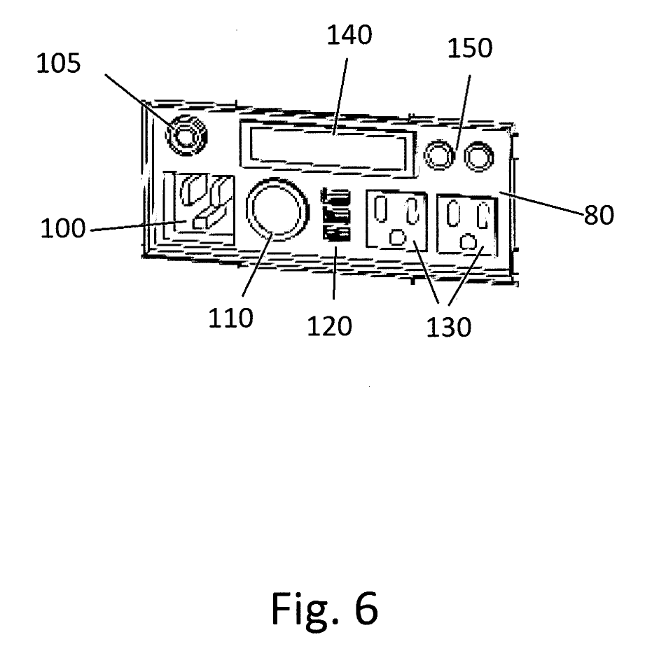

As shown in FIGS. 1, 3 and 4, the base 10 is made with acrylic plastic for the enclosure and a metal frame on the inside for the electronics. In the preferred embodiment, the base 10 is rectangular in shape and the size of a standard shoe box. The base 10 will have an ergonomic handle 20 on the top of the base 10. The handle 20 will slide to one side as shown in FIG. 2 to reveal the control panel 80. The control 80 has a number of controls, electronic ports and outlets as shown in FIG. 6. These outlets are hidden by the handle 20 when the charging station 1 is not in use. It will have a durable outer shell and a metal frame to hold the electronics inside the frame.

The base 1 will have solar panels 70 attached on the inside of the left side door 30 and the right side door 40 as well as the solar panel side of the base 10 that is covered by the doors. The doors 30, 40 will be attached to the base 1 through one or more hinges 60. The doors 30, 40 are flush with the solar side when closed. The charging station 1 will have a 12 Volt self-contained power system 200, High end solar panels 70, 2 or more USB ports 120, household receptacles like Power outlets of 120 volts plugs 130, and an LED screen 140 for tracking.

As shown in FIGS. 2 and 6, the control panel 80 is located on the top of the base 10 and behind the handle 20 when the charger 1 is not in use. The on/off button or switch 105 is located on the control panel 80. An LED screen 140 for tracking is located on the control panel. The control panel 80 has two or more USB charging ports 120 which are connect to the inverter 250. The control panel 80 will have an additional charging port 100 for a battery charger. The control panel 80 will have status lights 150 which will light up green when fully charges and red when not charged.

The current invention has foldable solar panels 70 and concealed 12-volt battery 200 make this indispensable device fully portable.

The 12 volt power inverter 250 will convert power from the 12 volt batteries to 110 volt AC power to provide power for the two or more USB outlets 120 and two household receptacles like 120-volt ports 130 proving more than enough power for all devices and real time charge when placed in direct sunlight. Up to four devices can be plugged in at once and keep charged and connected for as long as needed.

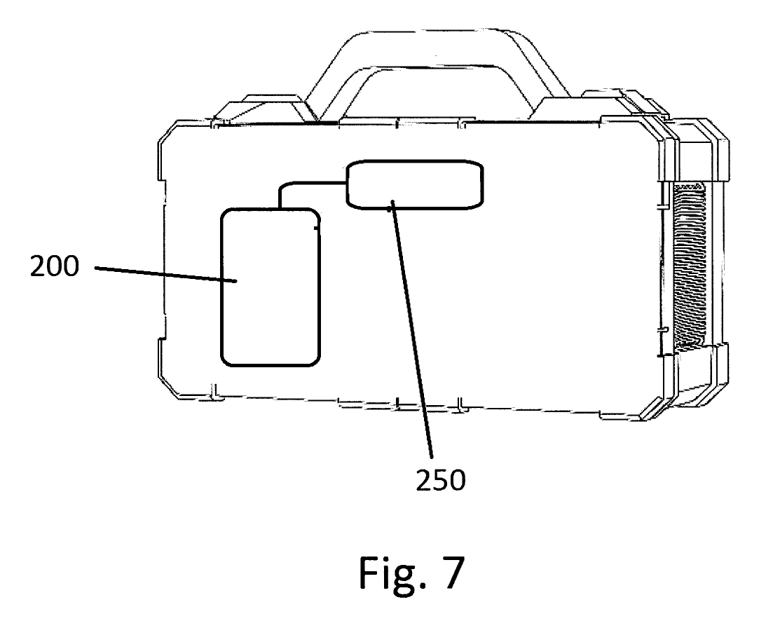

The batteries 200 will be 12 volts rechargeable. In the preferred embodiment, the batteries 200 will be sealed lead acid or AGM. The batteries 200 will be safe for both indoor and outdoor use and shipping. The batteries 200 will be attached to and fit in the base 1 as shown in FIG. 7. A power core can be plugged into the charging port 100 and plugged into a power source and be used to charge the batteries 200. The solar cells 70 will produce at least 12 volts in direct sunlight and 1.5 watts which can be used to charge the batteries 200 or provide power to the outlets. The solar cells 70 will provide real time charge when placed in direct sunlight

### Advantages

The solar charging station 1 removes the problem of running out of charge on electrical devices and cutting an outdoor excursion or family trip short. At around the size of a shoebox, it's the perfect accessory for the great outdoors. Its foldable solar panels and easy-to-carry handle make it highly portable.

Wherever a user is, whenever they need it, they can get solar energy on the go with the current invention. Keeps all devices fully charged. With 2 USB ports and 2 household receptacles like 120-volt outlets, it can charge up to four devices at the same time, including phones, laptop, refrigerator, and lamp.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A charging device comprising:
a base with two doors that cover a solar side when closed with a plurality of solar panels that cover the inside of the doors and the solar side, where said solar panels provide power to a plurality of batteries.

2. A charging device according to claim 1 further comprising:
Having an inverter connected to the batteries.

3. A charging device according to claim 1 further comprising:
Having the inverter connect to a plurality of outlets.

4. A charging device according to claim 3 further comprising:
Having the outlets be USB outlets.

5. A charging device according to claim 3 further comprising:
Having the outlets be 120 volt power outlets.

6. A charging device according to claim 1 further comprising:
Having the doors being attached to the sides of the base by hinges.

7. A charging device according to claim 1 further comprising:
Having a handle.

8. A charging device according to claim 7 further comprising:
Having the handle on the top of the base.

9. A charging device according to claim 8 further comprising:
Having the handle slide open.

10. A charging device according to claim 9 further comprising:
Having a control panel on the top of the base.

11. A charging device according to claim 10 further comprising:
Having an off/on switch, and a plurality of outlets on said control panel.

12. A charging device according to claim 1 further comprising:
Having a charging port connected to the battery.

13. A charging device comprising:
a base with a handle on top with two doors that cover a solar side when closed with a plurality of solar panels that cover the inside of the doors and the solar side, where said solar panels provide power to a plurality of batteries, having an inverter connected to the batteries, having the inverter connect to a plurality of outlets.

14. A charging device according to claim 13 further comprising:
Having the outlets be USB outlets.

15. A charging device according to claim 13 further comprising:
Having the outlets be 120-volt power outlets.

16. A charging device according to claim 13 further comprising:
Having the doors being attached to the sides of the base by hinges.

17. A charging device according to claim 13 further comprising:
Having a control panel on the top of the base.

18. A charging device according to claim 17 further comprising:
Having an off/on switch, and a plurality of outlets on said control panel.

19. A charging device according to claim 13 further comprising:
Having a charging port connected to the battery.

20. A process using the device according to claim 13.
